(19) United States
(12) Patent Application Publication
(10) Pub. No.: US 2026/0197540 A1
(43) Pub. Date: Jul. 9, 2026

(54) RECONSTRUCTING AN IMAGE FROM MULTIPLE IMAGES

(71) Applicant: NIL Technology ApS, Kongens Lyngby (DK)

(72) Inventors: Villads Egede Johansen, Copenhagen (DK); Yuriy Elesin, Copenhagen (DK)

(21) Appl. No.: 18/868,307

(22) PCT Filed: May 22, 2023
(86) PCT No.: PCT/EP2023/063683

§ 371 Date: Nov. 22, 2024

Related U.S. Application Data
(60) Provisional application No. 63/345,280, filed on May 24, 2022.

(51) Int. Cl. H04N 23/13; G06T 5/50

(52) U.S. Cl. CPC H04N 23/13; G06T 5/50

(57) ABSTRACT

An image capture method and apparatus are disclosed. An example method includes focusing, by each of a plurality of beam shaping elements, light onto a different respective one of a plurality of light sensitive regions, wherein each of the beam shaping elements is configured to capture images for image reconstruction. The method further includes acquiring, by each respective one of the light sensitive regions, a respective image based on the light focused thereon, and deconvolving the images to generate a reconstructed image, wherein the reconstructed image has an enhanced broadband image quality compared to the received images.

### FILED OF THE DISCLOSURE

The present disclosure relates to reconstructing an image from multiple images.

### BACKGROUND

Some optoelectronic imaging devices, such as cameras, have an optical channel that includes a beam shaping element (e.g., a lens) to focus incident light onto light sensitive regions (e.g., pixels) of an image sensor. The image sensor may be operable to convert optical signals into corresponding electrical signals, which then can be processed to reconstruct an image.

### SUMMARY

The present disclosure describes reconstructing an image from multiple images. An image capture method and apparatus are disclosed.

For example, in one aspect, the present disclosure describes a method that includes focusing, by each of multiple beam shaping elements, light onto a different respective one of multiple light sensitive regions, wherein each of the beam shaping elements is individually configured to capture images for image reconstruction. The method further includes acquiring, by each respective one of the light sensitive regions, a respective image based on the light focused thereon, and deconvolving the images to generate a reconstructed image, wherein the reconstructed image has an enhanced broadband image quality compared to the received images.

The present disclosure also describes an image capture apparatus that includes at least one sensor having multiple light sensitive regions each of which is operable to capture a respective image. The apparatus also includes beam shaping elements, each of which is operable to focus light onto a different respective one of the light sensitive regions, wherein each of the beam shaping elements is individually configured to capture images for image reconstruction. An image processor is operable to receive signals representing the respective images captured by the light sensitive regions. The image processor is further operable to deconvolve the received images and generate a reconstructed image based on the deconvolved images, wherein the reconstructed image has an enhanced broadband image quality compared to the received images.

Some implementations include one or more of the following features. For example, in some implementations, the beam shaping elements include at least one of diffractive lenses or meta-lenses. In some cases, each of the beam shaping elements may be configured for a particular wavelength or narrow range of wavelengths.

In some implementations, the image processor includes a neural network operable to deconvolve the received images. In some cases, each of the captured images has different respective sharp and blurred components, wherein the neural network is operable to combine the captured images to produce a sharper, color image.

In some implementations, the image processor is operable to perform an initial deblurring of the received images; detect sharp edges within each of the deblurred images; associate portions of each image that are within the detected sharp edges with features of one or more objects that reflect light at respective wavelengths; and combine portions of the deblurred images that are within the detected sharp edges to obtain the reconstructed image.

In some implementations, the image capture apparatus includes multiple light sensors, each of which includes a different respective one of the light sensitive regions. The image capture apparatus can includes, in some implementations, an optical projector operable to project an optical reference feature at a particular wavelength. A particular one of the beam shaping elements can be operable to focus reflected light onto a particular one of the light sensitive regions, and the at least one sensor can be operable to produce an image that includes a feature corresponding to the optical reference feature. The image processor can be operable to determine whether the feature in the image that corresponds to the optical reference feature is sufficiently sharp. In some instances, the image processor is further operable, in response to determining that the feature in the image that corresponds to the optical reference feature is insufficiently sharp, to generate a signal indicating that the image capture apparatus should be recalibrated or adjusted.

Some implementations include one or more of the following advantages. For example, in some implementations, the beam shaping elements collectively form a sharp image, even though, in some cases, no single one of the beam shaping elements is operable to produce an image of the same quality as the reconstructed image. In some instances, the method and system of the present disclosure can achieve enhanced broadband image quality.

The details of one or more implementations of the subject matter described in this specification are set forth in the accompanying drawings and the description below. Other aspects, features and advantages will be readily apparent from the description, the accompanying drawings and the claims.

### BRIEF DESCRIPTION OF THE DRAWINGS

FIG. 1 illustrates an example imaging system in accordance with the present disclosure.

FIG. 2 illustrates examples of images generated, respectively, by each of multiple optical sensors in the system of FIG. 1.

FIG. 3 is a flow chart showing an example method for obtaining a reconstructed image in accordance with some implementations.

FIG. 4 illustrates another example imaging system in accordance with the present disclosure.

FIG. 5 illustrates a further example imaging system in accordance with the present disclosure.

FIG. 6 illustrates examples of images generated, respectively, by each of multiple optical sensors in the system of FIG. 5.

### DETAILED DESCRIPTION

A beam shaping element in an optoelectronic imaging device that focuses incident light onto light sensitive regions of an image sensor can be implemented, for example, as a diffractive lens or a meta-lens. Such lenses sometimes are designed for optimal operation at a particular wavelength (λ). On the other hand, light (e.g., visible, infra-red) reflected from one or more objects in a scene whose image is to be acquired by the imaging device may include multiple different wavelengths or a spectrum of wavelengths. That is, some objects (or portions of an object) in the scene may reflect primarily a first wavelength (λ1), whereas other objects (or portions of an object) in the scene may primarily reflect a second, different wavelength (λ2). Thus, if the lens is optimized, for example, for operation with light of the first wavelength (λ1), portions of the scene that reflect light primarily of other wavelengths (e.g., λ2) will tend to be somewhat blurry as a result of diffraction. The present disclosure describes an imaging system and method that, in some implementations, can help obtain a reconstructed image that more closely resembles the original scene whose image is acquired. Further, the imaging system and method can be used regardless of whether the beam shaping elements are operable for any particular wavelength or range of wavelengths to form a sharp image. That is, in some implementations, the system and method can be used for reconstruction even where the acquired images are blurred at all wavelengths.

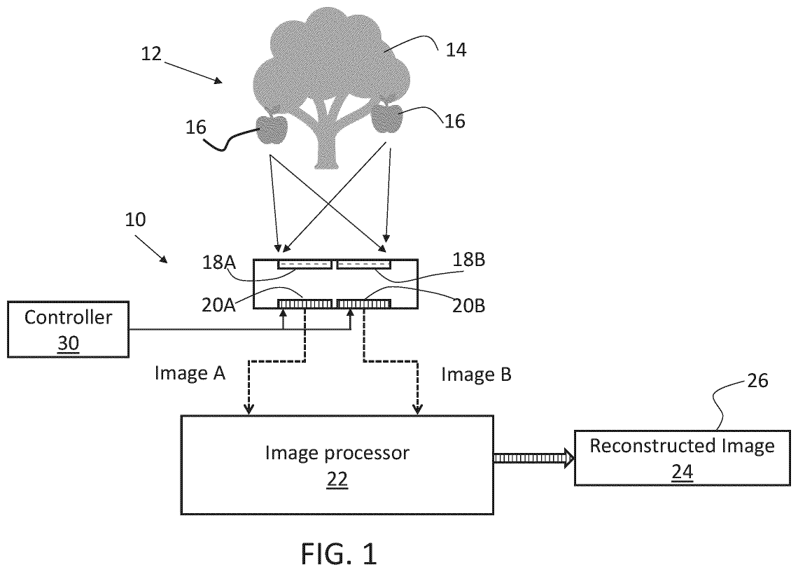

As shown in the example of FIG. 1, an image capture system 10 is operable to acquire images of one or more objects 14, 16 in a scene 12 and to process the acquired images to obtain a reconstructed image 24 of the objects in the scene. The image capture system 10 can include multiple sensors 20A, 20B, each of which is operable to detect optical signals and convert the detected optical signals into corresponding electrical signals. Each sensor 20A, 20B has respective light sensitive regions (e.g., pixels) and can be implemented, for example, as a CCD sensor, which is operable to output electrical signals representing the captured image. For example, as shown in FIG. 1, a first sensor 20A is operable to output a first image A, and a second sensor is operable to output a second image B. In some implementations, instead of separate sensors 20A, 20B, a single large optical sensor can be provided, where a first light sensitive area of the sensor is used to capture and generate the first image A, and a second light sensitive area of the sensor is used to capture and generate the second image B.

As further shown in FIG. 1, the image capture system 10 also includes respective beam shaping elements (e.g., lenses) 18A, 18B to focus light reflected by objects in the scene 12 onto respective ones of the sensors 20A, 20B. Each lens 18A, 18B can be implemented, for example, as a diffractive lens or a meta-lens. Further, each respective lens 18A, 18B can, in some instances, be designed for a particular respective wavelength or narrow range of wavelengths. That is, each lens may be optimized to focus light, for example, in a visible region (e.g., red, blue or green) or infra-red region of the electromagnetic spectrum. For example, a first lens 18A may be optimized for a first wavelength λ1 (e.g., a narrow range of wavelengths centered about λ1), whereas a second lens 18B may be optimized for a second, different wavelength λ2 (e.g., a narrow range of wavelengths centered about λ2). In this context, a narrow range of wavelengths can be, for example, wavelengths within ten nanometers (nm) of the center wavelength for that range. The ranges may vary (e.g., more or less) for some implementations. In some implementations, the optical beam shaping elements may produce images that are not sharp at any particular wavelength.

As each beam shaping element 18A, 18B may, in some instances, be optimized for a particular respective wavelength or narrow range of wavelengths, there may be no need, in some implementations, for optical filters to be used in conjunction with the lens. In such implementations, as there are no filters in front of the sensors, no light is discarded, which may allow more energy to be captured than filter-based image sensors. This, in turn, can result in a system having higher sensitivity. Nevertheless, in some cases, respective optical filters may be used in combination with one or more of the beam shaping elements 18A, 18B.

The image capture system 10 further includes an image processor 22 that is operable to receive the images from the sensors 20A, 20B and to process the images together so as to obtain a reconstructed image 24. The reconstructed image 24 can be stored in memory and/or can be displayed on a display 26 (e.g., a display monitor or display screen).

In some situations, different objects in the scene 12 may reflect, respectively, different wavelengths. To illustrate an example of operation of the image capture system, it is assumed that the scene includes one or more objects 14 that reflect light at the first wavelength λ1. It is further assumed for the sake of illustration that the scene also includes one or more other objects 16 that reflect light at the second wavelength λ2. Nevertheless, in some cases, a particular object may reflect light at more than wavelength (e.g., both wavelengths λ1 and λ2).

In operation, a controller 30 can generate one or more signals to trigger the sensors 20A, 20B to acquire respective images of the scene 12 at a particular moment. The signals from the controller 30 may be generated, for example, in an automated fashion or in response to user input. In response, some of the light reflected by the objects 14, 16 in the scene 12 passes through the lenses 18A, 18B and is detected, respectively, by the sensors 20A, 20B. Signals output by the first sensor 20A represent the first image A, and signals output by the second sensor 20B represent the second image B.

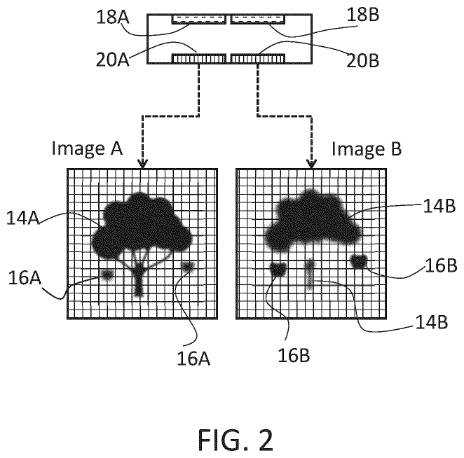

Both the first image A and the second image B may include features based on light detected at the first wavelength λ1 and at the second wavelength λ2. That is, as shown in FIG. 2, the first image A (i.e., the output of the first sensor 20A) can include first features 14A based on light detected at the first wavelength λ1, as well as second features 16A based on light detected at the second wavelength λ2. As the first lens 18A that focuses light onto the first sensor 20A is optimized for light at the first wavelength λ1, the first features 14A will tend to be sharper than the second features 16A, which may be slightly blurry.

Likewise, as shown in FIG. 2, the second image B (i.e., the output of the second sensor 20B) can include first features 14B based on light detected at the first wavelength λ1, as well as second features 16B based on light detected at the second wavelength λ2. As the second lens 18B that focuses light onto the second sensor 20B is optimized for light at the second wavelength λ2, the second features 16B will tend to be sharper than the first features 14B, which may be slightly blurry.

Both image A and image B are provided as input to the image processor 22, which is operable to deconvolve the images A and B to obtain a reconstructed image 24. In this case, the image deconvolution facilitates reconstruction of a latent image from two or more degraded images. That is, multiple images (each having different respective sharp and blurred components) can be combined to produce a relatively sharp, color image.

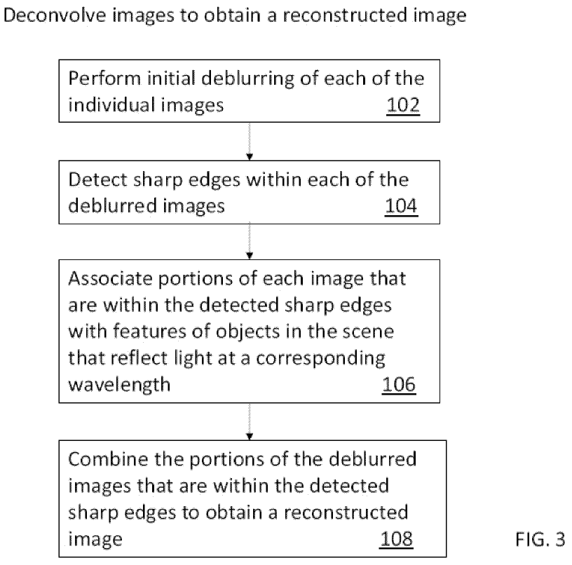

As shown in FIG. 3, in some implementations, the image processor 22 is operable to process the images to perform an initial deblurring of the individual images A and B (FIG. 3, at 102). Thus, the deblurring operation can be applied, for example, as part of a pre-processing stage. If the point spread function (PSF) of the optical systems (e.g., the lenses 18A, 18B) is known or can be computed, non-blind deconvolution techniques, for example, can be used for the deblurring. If the PSF of the optical systems is unknown, a blind deconvolution technique can be used to deblur the images (i.e., recover a relatively sharp version of an image from a blurred version). Other deblurring techniques can be used for some implementations.

As further indicated by FIG. 3, the method includes detecting sharp (e.g., high-contrast) edges within each of the deblurred images (FIG. 3, at 104). Then, the portions of each image that are within the detected sharp edges can be associated with features of objects 14, 16 in the scene 12 that reflect light at a corresponding one of the wavelengths (e.g., λ1 or λ2) (FIG. 3, at 106). That is, portions of the first deblurred image A that are within the detected sharp edges can be associated with features of objects 14, 16 in the scene 12 that reflect light at the first wavelength λ1. Likewise, portions of the second deblurred image B that are within the detected sharp edges can be associated with features of objects 14, 16 in the scene 12 that reflect light at the second wavelength λ2. Other portions of the respective deblurred images may, in some instances, be ignored (e.g., discarded). On the other hand, in some implementations (e.g., those that use a neural network), the other portions of the respective deblurred images may be beneficial as well and, thus, might not be discarded. The portions of the deblurred images that are within the detected sharp edges then can be combined to obtain the reconstructed image 24 (FIG. 3, at 108).

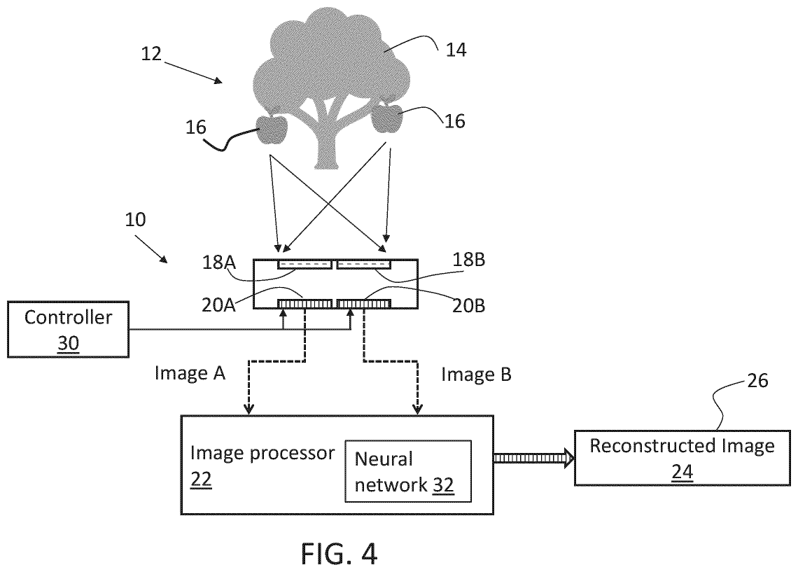

As shown in FIG. 4, in some implementations, the image processor 22 includes a neural network 32 to deconvolve the images A and B to obtain the reconstructed image 24. Thus, in some instances, the image processor 22 can incorporate artificial intelligence and may include iterative and/or deep learning techniques.

Although in the foregoing examples a latent image is reconstructed from two degraded images, more generally the latent image can be reconstructed from two or more degraded images (e.g., an array of images). For example, the image capture system can include an array of sensors (e.g., an array of 4-32 sensors), each of which has a respective associated beam shaping element (e.g., a diffractive lens or meta-lens) that is tailored for operation with a different respective wavelength. Each sensor is operable to produce, for example, an image of a scene. Yet, depending on the wavelength(s) of light reflected by various objects in the scene, different ones of the images may contain some features that are relatively sharp and others that are somewhat blurry. The image processor is operable to deconvolve the various images obtained from the sensors so as to obtain a reconstructed version of the latent image.

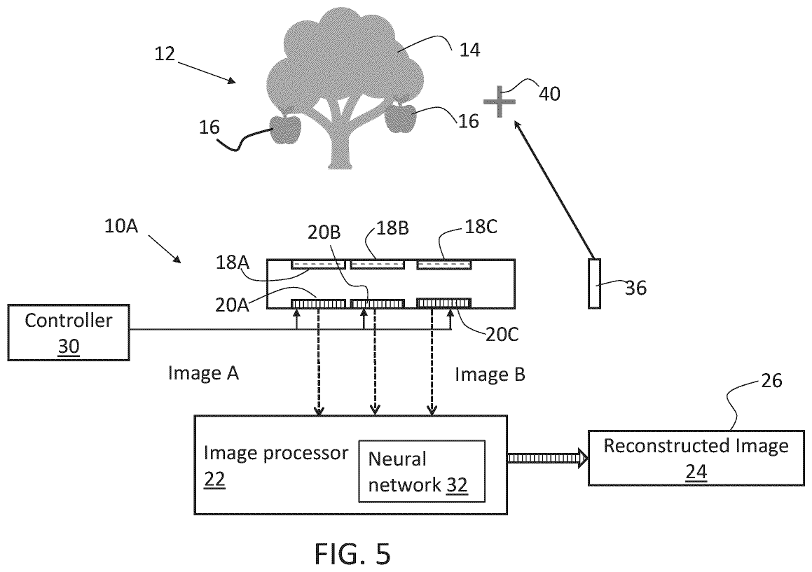

Some implementations also include additional features to facilitate calibration or recalibration of the image capture system. Recalibration may be desirable, for example, to correct for thermal effects on the optical sensors. As shown in FIG. 5, an image capture system 10A can include an optical projector 36 operable to project an optical reference feature 40 onto the scene at a particular wavelength λ3. In addition to the first and second optical sensors 20A, 20B and their associated lenses 18A, 18B, the image capture system 10A further includes a third optical sensor 20C and an associated third lens (e.g., diffractive lens or meta-lens) 18C. The third lens 18C can be optimized for the wavelength λ3 (e.g., a narrow range of wavelengths centered about λ3) and is operable to focus incident light onto the third sensor 20C.

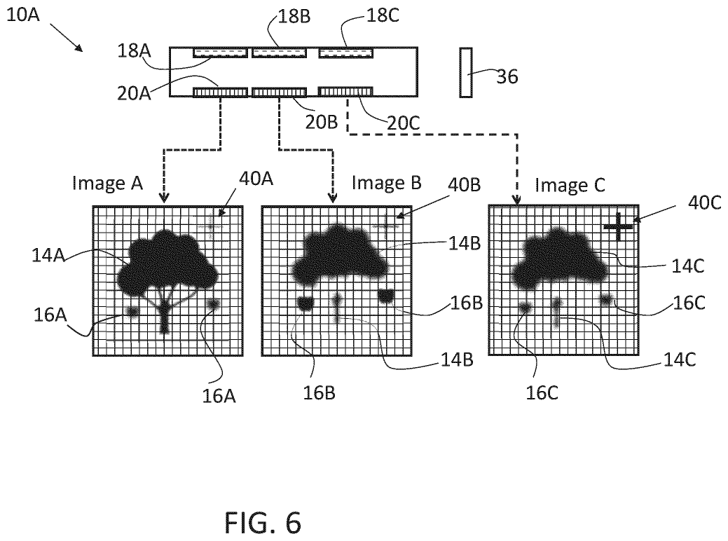

As described above with respect to the sensors 20A, 20B, the third sensor 20C also has light sensitive regions (e.g., pixels) and can be implemented, for example, as a CCD sensor, which is operable to output electrical signals representing the captured image. As shown in FIG. 6, the third sensor 20C is operable to output a third image C. In some implementations, a single large optical sensor can be provided, where a first light sensitive area of the sensor is used to capture and generate the first image A based on light passing through the first lens 18A, a second light sensitive area of the sensor is used to capture and generate the second image B based on light passing through the second lens 18B, and a third light sensitive area of the sensor is used to capture and generate a third image C based on light passing through the third lens 18C.

Each of the images A, B and C may include features based on light detected at the first wavelength λ1, the second wavelength λ2, and third wavelength λ3. That is, as shown in FIG. 6, the first image A (i.e., the output of the first sensor 20A) can include first features 14A based on light detected at the first wavelength λ1, second features 16A based on light detected at the second wavelength λ2, and third features 40A based on light detected at the third wavelength λ3 (e.g., corresponding to the reference feature 40). As the first lens 18A that focuses light onto the first sensor 20A is optimized for light at the first wavelength λ1, the first features 14A will tend to be sharper than the second and third features 16A, 40A, which may be slightly blurry.

Likewise, as shown in FIG. 6, the second image B (i.e., the output of the second sensor 20B) can include first features 14B based on light detected at the first wavelength λ1, second features 16B based on light detected at the second wavelength λ2, and third features 40B based on light detected at the third wavelength λ3 (e.g., corresponding to the reference feature 40). As the second lens 18B that focuses light onto the second sensor 20B is optimized for light at the second wavelength λ2, the second features 16B will tend to be sharper than the first and third features 14B, 40B, which may be slightly blurry.

As further shown in the example of FIG. 6, the third image C (i.e., the output of the third sensor 20C) can include first features 14C based on light detected at the first wavelength λ1, second features 16C based on light detected at the second wavelength λ2, and third features 40C based on light detected at the third wavelength λ3 (e.g., corresponding to the reference feature 40). As the third lens 18C that focuses light onto the third sensor 20C is optimized for light at the third wavelength λ3, the third features 40C, which correspond to the reference feature 40, should be relatively sharp, whereas the other features 14C, 16C may be somewhat blurry. If the features 40C in the image C, are not sufficiently sharp, one or more optical components of the image capture system 10A may need to be adjusted. For example, the image processor can be operable, in response to determining that the feature in the image that corresponds to the optical reference feature is insufficiently sharp, to generate a signal indicating that the image capture apparatus should be recalibrated or adjusted.

Various aspects of the subject matter and the functional operations described in this specification (e.g., operations described in connection with the image processor 22, the neural network 32, and/or the controller 30) can be implemented in digital electronic circuitry, or in computer software, firmware, or hardware. Thus, aspects of the subject matter described in this specification can be implemented, for example, as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The apparatus can include, in addition to hardware, code that creates an execution environment for the computer program in question, e.g., code that constitutes processor firmware.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The image capture system described in this disclosure can be used in various applications including, for example, in the reconstruction of RGB images or hyperspectral images (e.g., medical, quality control, satellite images).

While this document contains many specific implementation details, these should not be construed as limitations on the scope of any inventions or of what may be claimed, but rather as descriptions of features specific to particular embodiments. Certain features that are described in this document in the context of separate embodiments can also can be implemented in combination in a single embodiment. Conversely, various features that are described in the context of a single embodiment can also can be implemented in multiple embodiments separately or in any suitable sub-combination. Various modifications can be made to the foregoing examples. Accordingly, other implementations also are within the scope of the claims.

1. An image capture apparatus comprising:
at least one sensor having a plurality of light sensitive regions each of which is operable to capture a respective image;
beam shaping elements, each of which is operable to focus light onto a different respective one of the light sensitive regions, wherein each of the beam shaping elements individually is configured to capture images for image reconstruction;
an image processor operable to receive signals representing the respective images captured by the light sensitive regions, wherein the image processor is further operable to deconvolve the received images and generate a reconstructed image based on the deconvolved images, wherein the reconstructed image has an enhanced broadband image quality compared to the received images.

2. The image capture apparatus of claim 1 wherein the beam shaping elements include diffractive lenses.

3. The image capture apparatus of claim 1 wherein the beam shaping elements include meta-lenses.

4. The image capture apparatus of claim 1, wherein the image processor includes a neural network operable to deconvolve the received images.

5. The image capture apparatus of claim 4 wherein each of the captured images has different respective sharp and blurred components, wherein the neural network is operable to combine the captured images to produce a sharper, color image.

6. The image capture apparatus of claim 1, wherein the image processor is operable to:
perform an initial deblurring of the received images;
detect sharp edges within each of the deblurred images;
associate portions of each image that are within the detected sharp edges with features of one or more objects that reflect light at respective wavelengths; and
combine portions of the deblurred images that are within the detected sharp edges to obtain the reconstructed image.

7. The image capture apparatus of claim 1, including a plurality of light sensors, each of which includes a different respective one of the light sensitive regions.

8. The image capture apparatus of claim 1, further including:
an optical projector operable to project an optical reference feature at a particular wavelength,
wherein:
a particular one of the beam shaping elements is operable to focus reflected light onto a particular one of the light sensitive regions, and
the at least one sensor is operable to produce an image that includes a feature corresponding to the optical reference feature, and
the image processor is operable to determine whether the feature in the image that corresponds to the optical reference feature is sufficiently sharp.

9. The image capture apparatus of claim 8 wherein the image processor is further operable, in response to determining that the feature in the image that corresponds to the optical reference feature is insufficiently sharp, to generate a signal indicating that the image capture apparatus should be recalibrated or adjusted.

10. An image capture method comprising:
focusing, by each of a plurality of beam shaping elements, light onto a different respective one of a plurality of light sensitive regions, wherein each of the beam shaping elements is individually is configured to capture images for image reconstruction;
acquiring, by each respective one of the light sensitive regions, a respective image based on the light focused thereon; and
deconvolving the images to generate a reconstructed image, wherein the reconstructed image has an enhanced broadband image quality compared to the received images.

11. The method of claim 10 wherein the beam shaping elements include diffractive lenses.

12. The method of claim 10 wherein the beam shaping elements include meta-lenses.

13. The method of claim 10, including using a neural network to deconvolve the images.

14. The method of claim 13 wherein each of the acquired images has different respective sharp and blurred components, the method including combining the acquired images to produce a sharper, color image.

15. The method of claim 10, further including:
performing an initial deblurring of the acquired images;
detecting sharp edges within each of the deblurred images;
associating portions of each image that are within the detected sharp edges with features of one or more objects that reflect light at respective wavelengths; and
combining portions of the deblurred images that are within the detected sharp edges to obtain the reconstructed image.

16. The methods of claim 10, further including:
projecting an optical reference feature at a particular wavelength;
focusing reflected light, by a particular one of the beam shaping elements, onto a particular one of the light sensitive regions;
producing an image, based on signals from the particular one of the light sensitive regions, wherein the image includes a feature corresponding to the optical reference feature; and
determining, by an image processor, whether the feature in the image that corresponds to the optical reference feature is sufficiently sharp.

17. The method of claim 16 further including, in response to determining that the feature in the image corresponding to the optical reference feature is insufficiently sharp, generating a signal indicating a need for recalibration.
